(19) United States
(12) Patent Application Publication
(10) Pub. No.: US 2014/0245457 A1
(43) Pub. Date: Aug. 28, 2014

(54) METHOD AND DEVICE FOR INITIATING PRIVACY MODE OF DATA PROCESSING APPARATUS

(71) Applicant: TENCENT TECHNOLOGY (SHENZHEN) COMPANY LIMITED, Shenzhen (CN)

(72) Inventors: Xuesheng Qi, Shenzhen (CN); Yong Chen, Shenzhen (CN)

(73) Assignee: TENCENT TECHNOLOGY (SHENZHEN) COMPANY LIMITED, Shenzhen (CN)

(21) Appl. No.: 14/256,700

(22) Filed: Apr. 18, 2014

Related U.S. Application Data
(63) Continuation of application No. PCT/CN2013/090369, filed on Dec. 24, 2013.

(30) Foreign Application Priority Data
Feb. 27, 2013 (CN) 201310061291.0
Dec. 24, 2013 (CN) PCT/CN2013/090369

(51) Int. Cl. G06F 21/60; G06F 21/31

(52) U.S. Cl. CPC G06F 21/60; G06F 21/31
USPC 726/26

(57) ABSTRACT

This application discloses method and device for initiating privacy mode of data processing apparatus, the method includes: setting privacy space as privacy mode to protect corresponding privacy information on the data processing apparatus, setting authentication information corresponding to the privacy space and setting specified interface for inputting the authentication information; Monitoring input information on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.

### CROSS-REFERENCE TO RELATED APPLICATIONS

This application is a continuation application of PCT Patent Application No. PCT/CN2013/090369, entitled “METHOD AND DEVICE FOR INITIATING PRIVACY MODE OF DATA PROCESSING APPARATUS” filed on Dec. 24, 2013, which claims priority to Chinese Patent Application No. 201310061291.0, entitled “METHOD AND DEVICE FOR INITIATING PRIVACY MODE OF DATA PROCESSING APPARATUS” filed to Chinese Patent Office on Feb. 27, 2013, which is herein incorporated by reference in its entirety.

### FIELD OF THE INVENTION

This application relates to field of data processing technique of data processing apparatus, and in particular relates to method and device for initiating privacy mode of data processing apparatus.

### DESCRIPTION OF THE PRIOR ART

In current work and life, a data processing apparatus with data processing capability such as a computer, a mobile phone, a palm computer, a tablet computer or the like have come into wide use. A portable data processing apparatus such as a mobile phone, a palm computer, a tablet computer or the like especially become essential instrument carried by people.

With amount of information stored in the data processing apparatus become more and more, the resultant problem of privacy protection has become more and more important. Especially the mobile phone, it is not only a means of communication, and also stores a lot of individual information therein, once it is lost or lent to others, there is a large risk of leakage of privacy information.

There is a solution of the protection of the privacy information in the prior arts, that is, the privacy information that needs to be protected such as contact, message, phone call record, mail, schedule or the like in the data processing apparatus is encapsulated into one or more privacy protection program. If someone wants to view the privacy information, he needs to click the privacy protection program on the data processing apparatus, the privacy protection program would prompt user to input a password, and the privacy protection program is initiated after a correct password is input. Initiating the privacy protection program is equivalent to entering into a privacy mode, user can view relevant privacy information under the privacy mode.

However, the prior arts limits right of accessing the privacy mode by the user directly, though the privacy information of the user may be protected to a certain degree, this solution has suggested others explicitly that, there is a privacy in this privacy protection program, but it needs password to be accessed, this explicit suggestion may lead others to generate a motive of cracking the password, the password may be cracked easily with the conventional password crack technique, so that the privacy information of the user is leaked. At the same time, in the prior arts, there needs a long operation path in the procedure of entering into the privacy mode, that is, the apparatus needs to be operated to find the privacy protection program, which includes operations such as screen unlock, searching for privacy protection program in the menu or the like, and then the privacy protection program is clicked, and a password is input, and so on, so that the privacy mode is entered, which increases the operational steps of the user, and has a complicate manner of man-machine interaction.

### BRIEF DESCRIPTION OF THE INVENTION

In terms of this, the main object of the present invention is to provide method and device for initiating a privacy mode of a data processing apparatus to increase security of privacy information of user in the data processing apparatus while reduce the operation path of the user so as to facilitate the user to initiate the privacy mode rapidly.

The technical solution of the embodiments of the present invention is implemented as follows:
A method for initiating privacy mode of data processing apparatus including:
Setting procedure including setting privacy space on the data processing apparatus as privacy mode to protect corresponding privacy information, setting authentication information corresponding to the privacy space and setting specified interface for inputting the authentication information; and
Authentication procedure including monitoring information input on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.
A device for initiating privacy mode of data processing apparatus including:
Setting module for setting privacy space on the data processing apparatus as privacy mode to protect corresponding privacy information, setting authentication information corresponding to the privacy space and setting specified interface for inputting the authentication information; and
Authentication module for monitoring information input on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.
A computer program in a computer-readable format for initiating privacy mode of data processing apparatus, the computer program causes the computer to execute the following procedures:
setting a privacy space on the data processing apparatus as privacy mode to protect corresponding privacy information, setting authentication information corresponding to the privacy space and setting a specified interface for inputting the authentication information; and
monitoring input information on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.
A computer readable medium in which a computer program in a computer-readable format stored, the computer program being for initiating privacy mode of data processing apparatus, the computer program causing a computer to execute the following procedures:
setting a privacy space on the data processing apparatus as privacy mode to protect corresponding privacy information, setting authentication information corresponding to the privacy space and setting a specified interface for inputting the authentication information; and
monitoring input information on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.

As compared with the prior arts, the embodiments of the present invention set the privacy space as the privacy mode for protecting the corresponding privacy information, in the procedure of initiating the privacy space, whether an input signal whose degree of similarity with the authentication information corresponding to the privacy space is higher than a corresponding threshold is received is detected in the specified interface for the authentication information corresponding to the privacy space, and if it is detected that the input sign whose degree of similarity with the authentication information corresponding to the privacy space is higher than a corresponding threshold is received, the privacy space is entered. Therefore, there would not be any suggestion to the user in the entire procedure of initiating the privacy space, thus, not only the privacy information is protected, but also others are made to misunderstand that there is no privacy information in this apparatus, which achieves such a purpose of “making others be unaware that I have the privacy information”, so as to avoid the motive of cracking the privacy information of other user and increase the security of the privacy information. At the same time, the embodiments of the present invention can set the specified interface for monitoring the input signal, thus the user can set his most common and most convenient interface as the specified interface, and as long as specified input signal of authentication information is input in such a specified interface, the corresponding privacy space can be initiated directly, which reduces the operation path of the user and facilitates the user to initiate the privacy mode rapidly.

### BRIEF DESCRIPTION OF THE DRAWINGS

FIG. 1 is a schematic diagram of a flow of the method for initiating the privacy mode of the data processing apparatus according to the embodiment of the present invention,

FIG. 2 is a schematic diagram of another flow of the method for initiating the privacy mode of the data processing apparatus according to the embodiment of the present invention,

FIG. 3 is a schematic diagram of the constitution of the device for initiating the privacy mode of the data processing apparatus according to the embodiment of the present invention,

FIG. 4 is a schematic diagram of another constitution of the device for initiating the privacy mode of the data processing apparatus according to the embodiment of the present invention,

FIG. 5 is a schematic diagram of yet another constitution of the device for initiating the privacy mode of the data processing apparatus according to the embodiment of the present invention,

FIG. 6 is a schematic block diagram of a hardware configuration of the data processing apparatus according to the embodiment of the present invention.

### DESCRIPTION OF EMBODIMENT

The present invention is further described detailed in combination with the accompanying drawings and the specific embodiment.

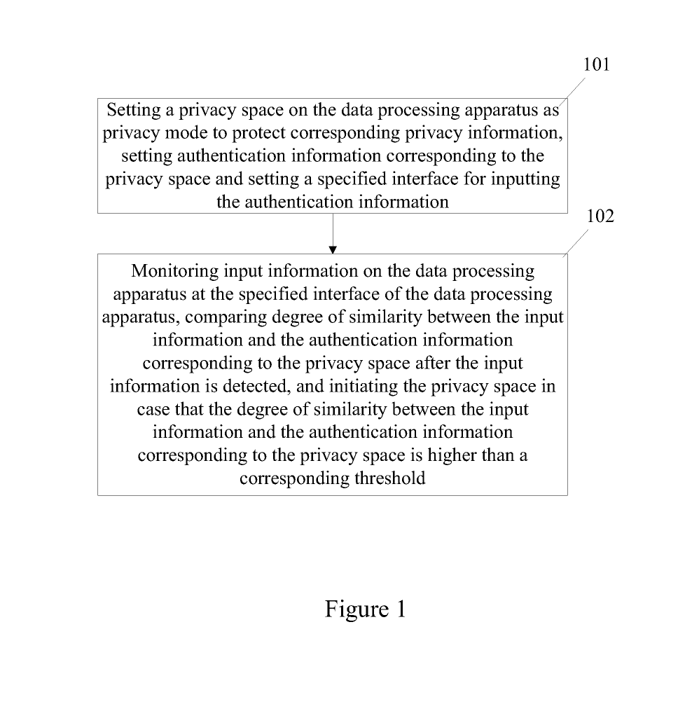

FIG. 1 is a schematic diagram of a flow of the method for initiating the privacy mode of the data processing apparatus according to the embodiment of the present invention. As shown in FIG. 1, the method includes:

Step 101 of setting procedure, which includes setting a privacy space on the data processing apparatus as a privacy mode to protect corresponding privacy information, setting authentication information corresponding to the privacy space and setting specified interface for inputting the authentication information;

Step 102 of authentication procedure including monitoring information input on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.

The method and device according to the embodiment of the present invention can be applied to all of the data processing apparatus, for example, a computer, a smart mobile phone, a palm computer, a tablet computer or the like. It is especially suitable for portable data processing apparatus such as a mobile phone, a palm computer, a tablet computer or the like.

In the following embodiments, the embodiments of the present invention are described by taking protecting the privacy information of the user in the mobile phone as example.

In the embodiments of the present invention, the created privacy space is substantially a privacy mode of the mobile phone for protecting the privacy information, a usual space is opposite to the privacy space and the privacy protection is not set therein and the usual space is as a public used space. Identification of the privacy space needs to be created as creating the privacy space, and each of the privacy spaces has an unique privacy space identification for distinguishing from other privacy spaces. The privacy information protected accordingly needs to be set in the privacy space, and the privacy information protected accordingly by the privacy space is only displayed in the privacy space.

For example, the case of a normal operation of the mobile phone corresponds to the usual space, and a certain privacy space can be entered (i.e., a certain privacy space of the mobile phone is entered) by inputting corresponding authentication information on the specified interface of authentication information corresponding to the privacy space.

In the embodiments of the present invention, the number of the privacy spaces is not limited, there can set more than one privacy spaces, wherein, for each of the privacy spaces, authentication information corresponding to the privacy space and specified interface for inputting the authentication information are set.

If a certain privacy space is initiated, the privacy information protected by this privacy space can be displayed, and if the privacy space is quitted, the privacy information protected by this privacy space can't be displayed.

The present invention are substantially implemented as a privacy protection program executed on the data processing apparatus, when the user needs to execute step 101, the privacy protection program is entered to create new privacy space and set corresponding privacy information protected accordingly by the privacy space, and it also needs to set the authentication information corresponding to the privacy space and set the specified interface for inputting the authentication information. The specified interface may be set by the user, or may be set in the privacy protection program by default.

If a certain privacy space needs to be initiated, the privacy space can only be entered when correct authentication information is input in the specified interface for inputting the authentication information corresponding to the privacy space. If the authentication information corresponding to a certain privacy space needs to be modified, the privacy space needs to be initiated according to the method of the embodiments of the present invention and the corresponding authentication information is reset in the privacy space, also the specified interface for inputting the authentication information can be reset, and the content and manner of the privacy information that needs to be protected is reset in the privacy space, even this privacy space can be deleted. Thus, even if other one knows that this mobile phone has the privacy protection program that can create the privacy space, he can't know the content of the privacy space set in this mobile phone and the authentication information corresponding thereto, even he enters the privacy protection program, and he can only add a new privacy space, so that the privacy space set in this mobile phone and the authentication information corresponding thereto can be protected more efficiently.

In the specific embodiment, the authentication information corresponding to the privacy space and the specified interface for inputting the authentication information may have many implementation modes. Two typical implementation modes are described as follows:

In the first implementation mode, the authentication information is gesture information, and the specified interface for inputting the authentication information is a screen lock interface or a desktop interface. Of course, in other embodiments, the specified interface for inputting the authentication information may also be set as other interfaces which are most common and most convenient for the user.

In the second implementation mode, the authentication information is a character string plus a specified special character, the specified interface is a dial interface of the data processing apparatus, for example, a telephone dial interface in the mobile phone.

The detailed setting procedure and the authentication procedure in the two implementation modes are described as follows.

In the implementation mode in which the authentication information is gesture information and the specified interface for inputting the authentication information is a screen lock interface or a desktop interface, in one specific embodiment, setting authentication information corresponding to the privacy space in step 101 specifically includes the following steps 111 to 112:

Step 111, prompting the user to input gesture information on the screen of the mobile phone, and using the gesture information as an authentication sample after gesture information input by the user (for example, gesture information such as slide path, written penmanship or the like) is detected; computing the key path of the authentication sample, for example, the key path of the authentication sample can be obtained by analyzing the contour and the sequence of the authentication sample.

Step 112, storing the key path in a storage region of the mobile phone as the authentication information corresponding to the current privacy space, and setting access authority for a screen lock interface program and/or a desktop interface program to access the storage region.

In this embodiment, the corresponding authentication procedure in step 102 specifically includes the following steps 211 to 214:

Step 211, monitoring the gesture information input by the user at the screen lock interface or the desktop interface of the mobile phone, specifically monitoring through a screen lock interface program or a desktop interface program.

Step 212, using the gesture information as the authentication sample after the gesture information input by the user is detected, and computing the key path of the authentication sample.

Step 213, the screen lock interface program or the desktop interface program reading the authentication information corresponding to the privacy space from the storage region, comparing the degree of similarity between the key path obtained in the previous step and the authentication information corresponding to the privacy space. If a plurality of privacy spaces is set, the program starts from the first privacy space, polls to compare the degree of similarity between the key path and the authentication information corresponding to each privacy space.

Step 214, initiating a certain privacy space in a case where the degree of similarity between the key path and the authentication information corresponding to the privacy space is higher than the corresponding threshold. Here, the corresponding threshold may be a preset threshold of the degree of similarity.

Further, in the implementation mode in which the authentication information is gesture information and the specified interface for inputting the authentication information is the screen lock interface or the desktop interface, in another specific embodiment, setting authentication information corresponding to the privacy space in step 101 specifically includes the following steps 121 to 123:

Step 121, prompting the user to input gesture information on the screen of the mobile phone, using a first time gesture information as an authentication sample after the first time gesture information input by the user (for example, gesture information such as slide path, written penmanship or the like) is detected, and computing a key path of the authentication sample.

Step 122, prompting the user once more to input gesture information once more on the screen of the mobile phone, using a second time gesture information as an authentication sample after the second time gesture information input by the user (for example, gesture information such as slide path, written penmanship or the like) is detected, and computing a key path of the authentication sample.

Step 123, comparing the degree of similarity between the key path of the current second time gesture information and the key path of the first time gesture information, using the key path of the current second time gesture information and the key path of the first time gesture information as the authentication information corresponding to the current privacy space if the degree of similarity is higher than a specified threshold (a preset threshold), storing the authentication information in storage region of the mobile phone, and setting access authority for the screen lock interface program and/or the desktop interface program to access the storage region; otherwise, returning to step 122.

In this embodiment, the corresponding authentication procedure in step 102 specifically includes the following steps 221 to 224:

Step 221, monitoring gesture information input by the user at the screen lock interface or the desktop interface of the mobile phone; specifically monitoring through the lock screen interface program or the desktop interface program.

Step 222, using the gesture information as the authentication sample after the gesture information input by the user is detected, and computing the key path of the authentication sample.

Step 223, the screen lock interface program or the desktop interface program reading the authentication information corresponding to the privacy space from the storage region, comparing the degree of similarity between the key path obtained in the previous step and any key path in the authentication information. If a plurality of privacy spaces is set, the program starts from the first privacy space, polls to compare the degree of similarity between the key path and any key path in the authentication information corresponding to each privacy space.

Step 224, initiating a certain privacy space in a case where the degree of similarity between the key path obtained in the previous step and any key path in the authentication information corresponding to the privacy space is higher than the corresponding threshold.

Since the usually displayed interface of the mobile phone by most of the user is the screen lock interface or the desktop interface, in the above embodiment, the user can enter the privacy space by inputting gesture information corresponding to the authentication information corresponding to the privacy space from the screen lock interface or the desktop interface directly, which significantly reduces the operation path of initiating the privacy space by the user and facilitates the user to initiate the privacy mode rapidly.

In the implementation mode in which the authentication information is the character string plus the specified special character and the specified interface is the dial interface of the mobile phone, setting the authentication information corresponding to the privacy space in step 101 specifically includes the following steps 131 to 132:

Step 131, prompting the user to input the character string; storing the character string plus the specified special character (for example, special character such as *, &, % or the like) in the storage region of the mobile phone as the authentication information corresponding to the current privacy space after the character string input by the user is received, and setting access authority for the dial interface program to access the storage region.

Step 132, notifying the user that the authentication information corresponding to the current privacy space is the character string plus specified special character input by the user, so that the user is made to know that the authentication information corresponding to the privacy space not only includes the character string input by the user in the previous step, and also the specified special character needs to be added behind the character string.

In this embodiment, the corresponding authentication procedure in step 102 specifically includes the following steps 231 to 234:

Step 231, monitoring the character string input by the user at the dial interface of the mobile phone.

Step 232, reading the authentication information corresponding to the privacy space from the storage region after the specified special character input by the user is detected, comparing the degree of similarity between all of the character string input by the user currently (including the character string input before the specified special character plus the specified special character) and the authentication information.

Step 233, initiating a certain privacy space in a case where all of the character string input by the user currently is fully identical to the authentication information corresponding to the privacy space.

Since the dial interface is one essential interface in all mobile phones whose function is to dial phone number, when the user inputs the authentication information in the dial interface, other people would think that the user is making phone call other than knowing that the user are entering into the privacy space, thus there is a strong invisibility, so as to achieve such a purpose of “making others be unaware that I have privacy information”, and in turn avoid the motive of cracking the privacy information of other users and increase the security of the privacy information.

Further, since the dial interface is a one key triggered interface in almost all mobile phones, therefore in the above embodiment, the user triggers the dial interface with one key, and then inputs the character string corresponding to the authentication information corresponding to the privacy space in the dial interface to enter into the privacy space directly, which reduces the operation path for initiating the privacy space by the user and facilitate the user to initiate the privacy mode rapidly as compared with the prior arts.

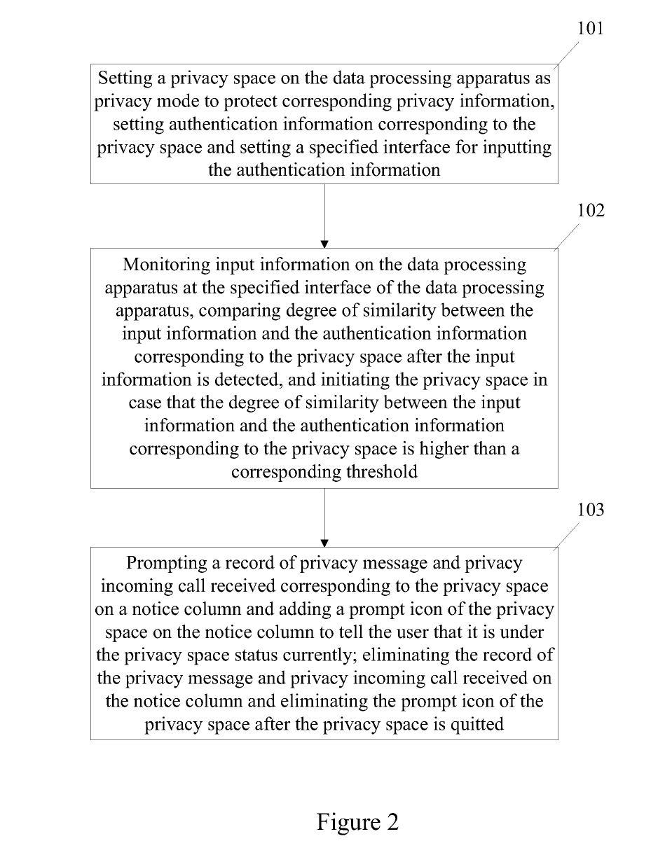

FIG. 2 is a schematic diagram of another flow of the method for initiating the privacy mode of the mobile phone according to the embodiment of the present invention. Referring to FIG. 2, in a further embodiment of the present invention, after initiating a certain privacy space, the method can further include:

Step 103, prompting a record of privacy message and privacy incoming call received corresponding to the privacy space on a notice column, and adding a prompt icon of the privacy space on the notice column to tell the user that it is under the privacy space status; and eliminating the record of the privacy message and privacy incoming call received on the notice column and eliminating the prompt icon of the privacy space after the privacy space is quitted.

In another implementation mode of the embodiments of the present invention, it may further set a specified shortcut operation for quitting the privacy space (for example, pressing a “home” key, a “power” key, a screen off operation or the like); And after initiating the privacy space, whether the specified shortcut operation occurs is detected, and the privacy space is quitted when the specified shortcut operation occurs is detected. With the processing of the present embodiment, when the user is operating the privacy information in the privacy space, if other one wants to look at the screen of the mobile phone of the user, or wants to borrow the mobile phone of the user, the user can quit the privacy space rapidly, so that other one can't know that the user is operating the privacy information at the previous moment, and when other one sees the screen of the mobile phone, the information on the screen of the mobile phone is non-privacy information in the usual space, there is no difference from the usual screen of the mobile phone, so that other user can't find that there is privacy information in the mobile phone, which achieves such a purpose of “making others be unaware that I have privacy information”, and in turn avoid the motive of cracking privacy information of other user and increase the security of the privacy information.

In another implementation mode of the embodiments of the present invention, after initiating the privacy space, it further includes: monitoring duration during which there is no operation (for example, 30 seconds), and when the duration during which there is no operation reaches a predetermined duration, the privacy space is quitted, or, whether screen off event occurs is detected, and if it is detected that the screen off event occurs, the privacy space is quitted. With this implementation mode, when the user does not use the mobile phone for a long time, for example, the user leaves the mobile phone on the table, the mobile phone can automatically quit from the privacy space, so that even other one picks up the mobile phone, he would see non-privacy information in the usual space, there is no difference from the usual screen of the mobile phone, so that other user can't find that there is privacy information in the mobile phone, which achieves such a purpose of “making others be unaware that I have privacy information”, and in turn avoid the motive of cracking privacy information of other user and increase the security of the privacy information.

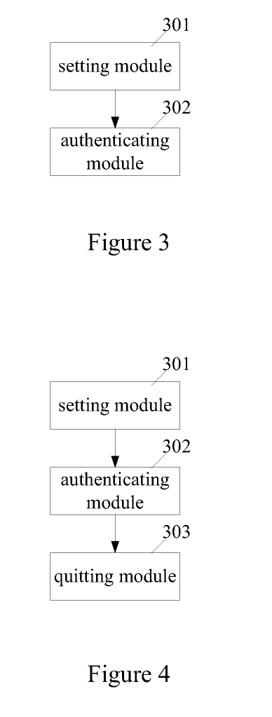

The embodiments of the present invention further disclose device for initiating the privacy mode of the data processing apparatus corresponding to the above method. FIG. 3 is schematic diagram of constitution of the device for initiating the privacy mode of the data processing apparatus. Referring to FIG. 3, the device includes:

Setting module 301 for setting privacy space as privacy mode on the data processing apparatus to protect corresponding privacy information, setting authentication information corresponding to the privacy space and setting specified interface for inputting the authentication information; and

Authentication module 302 for monitoring information input on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.

In a preferable implementation mode, the authentication information is gesture information, and the specified interface for inputting the authentication information is a screen lock interface or a desktop interface.

In another preferable implementation mode, the authentication information is a character string plus a specified special character, the specified interface is a dial interface of the data processing apparatus (for example, a telephone dial interface in the mobile phone).

In the implementation mode in which the authentication information is gesture information and the specified interface for inputting the authentication information is a screen lock interface or a desktop interface, in one specific embodiment, the setting module 301 specifically includes:

A first setting unit for setting a newly added privacy space and privacy information protected accordingly by the privacy space on the data processing apparatus; and

A second setting unit for prompting the user to input gesture information on the screen of the data processing apparatus for the newly added privacy space, using the gesture information as an authentication sample after the gesture information input by the user is detected, computing a key path of the authentication sample, storing the key path as the authentication information corresponding to the current newly added privacy space in the storage region of the data processing apparatus, and setting access authority for a screen lock interface program and/or a desktop interface program to access the storage region.

In this embodiment, the corresponding authentication module 302 is specifically for monitoring the gesture information input by the user on the screen lock interface or the desktop interface of the data processing apparatus; using the gesture information as the authentication sample after the gesture information input by the user is detected, and computing the key path of the authentication sample; reading the authentication information corresponding to the privacy space from the storage region and comparing the degree of similarity between the key path obtained in the previous step and the authentication information; and initiating a certain privacy space in a case where the degree of similarity between the key path and the authentication information corresponding to the privacy space is higher than a corresponding threshold.

In the implementation mode in which the authentication information is gesture information and the specified interface for inputting the authentication information is the screen lock interface or the desktop interface, in yet another specific embodiment, the setting module 301 specifically includes:

A first setting unit for setting a newly added privacy space and privacy information protected accordingly by the privacy space on the data processing apparatus; and

A second setting unit for prompting the user to input the gesture information on the screen of the data processing apparatus for the newly added privacy space, using a first time gesture information as an authentication sample after the first time gesture information input by the user is detected, and computing the key path of the authentication sample; prompting the user once more to input the gesture information once more on the data processing apparatus, using a second time gesture information as the authentication sample when the second time gesture information input by the user is detected, and computing the key path of the authentication sample; comparing the degree of similarity between the key path of the current second time gesture information and the key path of the first time gesture information, if the degree of similarity is higher than a specified threshold, storing the key path of the current second time gesture information and the key path of the first time gesture information as the authentication information corresponding to the current privacy space in the storage region of the data processing apparatus, and setting access authority for the screen lock interface program and/or the desktop interface program to access the storage region; otherwise, prompting the user once more to input the gesture information once more on the screen of the data processing apparatus;

In this embodiment, the corresponding authentication module 302 is specifically for monitoring the gesture information input by the user on the screen lock interface or the desktop interface of the data processing apparatus; using the gesture information as the authentication sample after the gesture information input by the user is detected, and computing the key path of the authentication sample; reading the authentication information corresponding to the privacy space from storage region and comparing the degree of similarity between the key path obtained in the previous step and any key path in the authentication information; and initiating a certain privacy space in a case where the degree of similarity between the key path obtained in the previous step and any key path in the authentication information corresponding to the privacy space is higher than the corresponding threshold.

In the implementation mode in which the authentication information is a character string plus a specified special character and the specified interface is a dial interface of the data processing apparatus, in a specific embodiment, the setting module 301 specifically includes:

A first setting unit for setting a newly added privacy space and privacy information protected accordingly by the privacy space on the data processing apparatus; and

A second setting unit for prompting the user to input the character string for the newly added privacy space, storing the character string plus the specified special character as the authentication information corresponding to the current privacy space in the storage region of the data processing apparatus after receiving the character string input by the user, and setting access authority for the dial interface program to access the storage region, notifying the user that the authentication information corresponding to the current privacy space is the character string plus the specified special character input by the user.

In this embodiment, the corresponding authentication module 302 is specifically for:

Monitoring the character string input by the user in the dial interface of the data processing apparatus; reading the authentication information corresponding to the privacy space from the storage region after the specified special character input by the user is detected, comparing the degree of similarity between all of the character string input by the user currently (including the character string input before the specified special character plus the specified special character) and the authentication information; and initiating a certain privacy space in a case where all of the character string input by the user currently is fully identical to the authentication information corresponding to the privacy space.

In the embodiments of the present invention, the setting module is specifically for setting more than one privacy spaces, wherein, the authentication information corresponding to the privacy space and the specified interface for inputting the authentication information are set for each privacy space.

FIG. 4 is a schematic diagram of another constitution of the device for initiating the privacy mode of the data processing apparatus according to the embodiment of the present invention. Referring to FIG. 4, the setting module 301 is further for setting a specified shortcut operation for quitting the privacy space. And the device further includes a quitting module 303 for monitoring whether the specified shortcut operation occurs after initiating the privacy space and quitting the privacy space when it detects that the specified shortcut operation has occur.

In a further embodiment, the quitting module 303 is also for monitoring a duration during which there is no operation after initiating the privacy space and quitting the privacy space when the duration during which there is no operation reaches a predetermined duration; or, monitoring whether screen off event occurs after initiating the privacy space, and if the screen off event occurs, the privacy space is quitted.

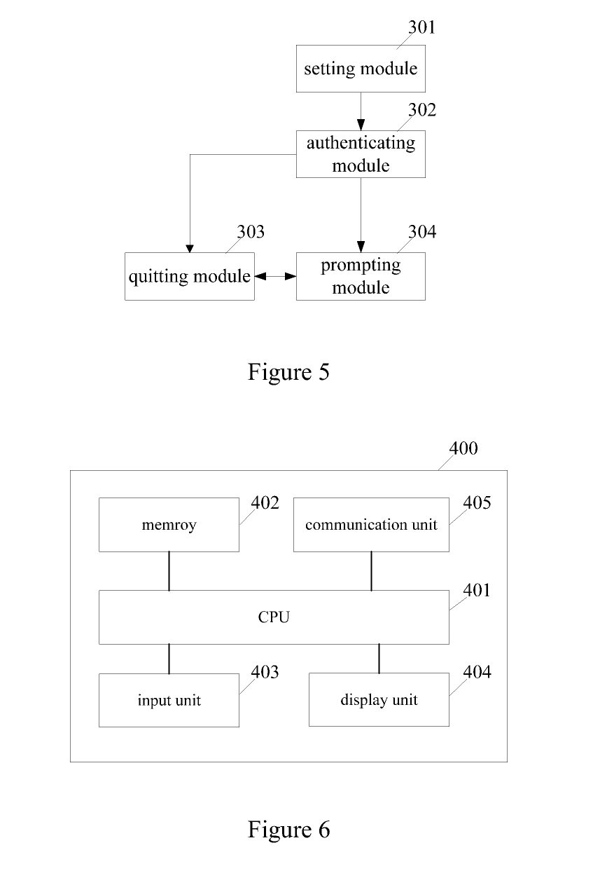

FIG. 5 is a schematic diagram of yet another constitution of the device for initiating the privacy mode of the data processing apparatus according to the embodiment of the present invention. Referring to FIG. 5, in a further embodiment of the present invention, the device further includes a prompting module 304 for prompting a record of privacy message and privacy incoming call received corresponding to the privacy space on a notice column after initiating the privacy space and adding a prompt icon of the privacy space on the notice column; and eliminating the record of the privacy message and privacy incoming call received on the notice column and eliminating the prompt icon of the privacy space after the privacy space is quitted.

The device of the embodiments of the present invention can be implemented as software that can be installed on the data processing apparatus, privacy information of the user on the data processing apparatus can be protected by using the software, it is especially suitable for the protection of the privacy information of the user of portable data processing apparatus such as a mobile phone or the like.

FIG. 6 is a schematic block diagram of a hardware configuration of the data processing apparatus according to the embodiment of the present invention. FIG. 6 illustrates a hardware structure of the data processing apparatus 400, which may be provided as a conventional mobile terminal. The hardware structure includes a central processing unit (CPU) 401, a memory 402, an input unit 403, a display unit 404, and a communication unit 405. And, if the mobile terminal is a smart mobile phone with touch control screen, the touch control screen can act as both of the input unit 403 and the display unit 404.

The method for initiating the privacy mode of the data processing apparatus according to the embodiment of the present invention can be embodied as a computer-executable program stored in the memory 402. And, when the computer-executable program is read out from the memory 402 and executed by the CPU 401, the CPU 401 functions as the quitting module 303, and functions as the setting module 301 and the authenticating module 302 together with the input unit 403, and functions as the prompting module together with the display unit 404. In the several embodiments provided by this application, it is understood that the disclosed system, device and method can be implemented by other means. For example, the above-described embodiment of the device is only schematic, for example, the division of the units is only a logical functional division, and there can be other manners of division in the actual implementation, for example, a plurality of units or components can be combined or integrated into another system, or some features can be neglected or are not implemented.

The above mentioned is only preferred embodiment of the present invention and does not limit the present invention, any of the modification, equivalent replacement, improvement or the like within the spirit and principle of the present invention should be included in the range sought for protection by the present invention.

1. A method for initiating privacy mode of data processing apparatus, comprising:
setting a privacy space on the data processing apparatus as privacy mode to protect corresponding privacy information, setting authentication information corresponding to the privacy space and setting a specified interface for inputting the authentication information; and
monitoring input information on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.

2. The method according to claim 1, wherein, the authentication information is information of operation of the data processing apparatus, and the specified interface for inputting the authentication information is a screen lock interface or a desktop interface.

3. The method according to claim 2, wherein,
setting the authentication information corresponding to the privacy space specifically comprises:
prompting a user to input gesture information on the data processing apparatus, using the gesture information as an authentication sample when the gesture information input by the user is detected, and computing a key path of the authentication sample;
storing the key path as the authentication information corresponding to the current privacy space in a storage region of the data processing apparatus; and
the authentication procedure specifically comprises:
monitoring the gesture information input by the user on the screen lock interface or the desktop interface of the data processing apparatus;
using the gesture information as the authentication sample after the gesture information input by the user is detected, and computing the key path of the authentication sample;
reading the authentication information corresponding to the privacy space from the storage region and comparing the degree of similarity between the key path obtained in the previous step and the authentication information; and
initiating a certain privacy space in a case where the degree of similarity between the key path and the authentication information corresponding to the privacy space is higher than a corresponding threshold.

4. The method according to claim 2, wherein,
setting the authentication information corresponding to the privacy space specifically comprises steps of:
A1, prompting the user to input the gesture information on the data processing apparatus, using a first time gesture information as the authentication sample when the first time gesture information input by the user is detected, and computing the key path of the authentication sample;
A2, prompting the user once more to input the gesture information once more on the data processing apparatus, using a second time gesture information as the authentication sample when the second time gesture information input by the user is detected, and computing the key path of the authentication sample; and
A3, comparing the degree of similarity between the key path of the current second time gesture information and the key path of the first time gesture information, if the degree of similarity is higher than a specified threshold, storing the key path of the current second time gesture information and the key path of the first time gesture information as the authentication information corresponding to the current privacy space in the storage region of the data processing apparatus, otherwise, returning to step A2; and
the authentication procedure specifically comprises:
monitoring the gesture information input by the user on the screen lock interface or the desktop interface of the data processing apparatus;
using the gesture information as the authentication sample after the gesture information input by the user is detected, and computing the key path of the authentication sample;
reading the authentication information corresponding to the privacy space from storage region and comparing the degree of similarity between the key path obtained in the previous step and any key path in the authentication information; and
initiating a certain privacy space in a case where the degree of similarity between the key path obtained in the previous step and any key path in the authentication information corresponding to the privacy space is higher than the corresponding threshold.

5. The method according to claim 1, wherein, the authentication information is a character string plus a specified special character, and the specified interface is a dial interface of the data processing apparatus.

6. The method according to claim 5, wherein, setting the authentication information corresponding to the privacy space specifically comprises:
prompting the user to input a character string;
storing the character string plus a specified special character as the authentication information corresponding to the current privacy space in the storage region of the data processing apparatus after receiving the character string input by the user; and
notifying the user that the authentication information corresponding to the current privacy space is the character string plus the specified special character input by the user; and
the authentication procedure specifically comprises:
monitoring the character string input by the user in the dial interface of the data processing apparatus;
reading the authentication information corresponding to the privacy space after the specified special character being input by the user is detected, and comparing the degree of similarity between all of the character string input by the user currently and the authentication information; and
initiating a certain privacy space in a case where all of the character string input by the user currently is fully identical to the authentication information corresponding to the privacy space.

7. The method according to claim 1, wherein, after initiating the privacy space, the method further comprises:
prompting a record of privacy message and privacy incoming call received corresponding to the privacy space on a notice column and adding a prompt icon of the privacy space on the notice column; and
eliminating the record of the privacy message and privacy incoming call received on the notice column and eliminating the prompt icon of the privacy space after the privacy space is quitted.

8. The method according to claim 1, wherein, the method further comprises:
setting a specified shortcut operation for quitting the privacy space; and
monitoring whether the specified shortcut operation occurs after initiating the privacy space, and quitting the privacy space when it detects that the specified shortcut operation occurs.

9. The method according to claim 1, wherein, after initiating the privacy space, the method further comprises:
monitoring a duration during which there is no operation, and quitting the privacy space when the duration during which there is no operation reaches a predetermined duration; or
monitoring whether a screen off event occurs, and quitting the privacy space if the screen off event occurs.

10. A device for initiating privacy mode of data processing apparatus, comprises:
a setting module for setting a privacy space on the data processing apparatus as privacy mode to protect corresponding privacy information, setting authentication information corresponding to the privacy space and setting a specified interface for inputting the authentication information; and
an authentication module for monitoring input information on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.

11. The device according to claim 10, wherein, the authentication information is information of operation of the data processing apparatus, and the specified interface for inputting the authentication information is a screen lock interface or a desktop interface.

12. The device according to claim 11, wherein,
the setting module specifically comprises:
a first setting unit for setting a newly added privacy space and privacy information protected accordingly by the privacy space on the data processing apparatus; and
a second setting unit for prompting the user to input the gesture information on the screen of the data processing apparatus for the newly added privacy space, using the gesture information as an authentication sample after the gesture information input by the user is detected, computing a key path of the authentication sample, storing the key path as the authentication information corresponding to the current newly added privacy space in the storage region of the data processing apparatus; and
the authentication module is specifically for:
monitoring the gesture information input by the user on the screen lock interface or the desktop interface of the data processing apparatus;
using the gesture information as the authentication sample after the gesture information input by the user is detected, and computing the key path of the authentication sample;
reading the authentication information corresponding to the privacy space from the storage region and comparing the degree of similarity between the key path obtained in the previous step and the authentication information; and
initiating a certain privacy space in a case where the degree of similarity between the key path and the authentication information corresponding to the privacy space is higher than a corresponding threshold.

13. The device according to claim 11, wherein,
the setting module specifically comprises:
a first setting unit for setting a newly added privacy space and privacy information protected accordingly by the privacy space on the data processing apparatus; and
a second setting unit for prompting the user to input the gesture information on the screen of the data processing apparatus for the newly added privacy space, using a first time gesture information as an authentication sample after the first time gesture information input by the user is detected, and computing the key path of the authentication sample; prompting the user once more to input the gesture information once more on the data processing apparatus, using a second time gesture information as the authentication sample when the second time gesture information input by the user is detected, and computing the key path of the authentication sample; comparing the degree of similarity between the key path of the current second time gesture information and the key path of the first time gesture information, storing the key path of the current second time gesture information and the key path of the first time gesture information as the authentication information corresponding to the current privacy space in the storage region of the data processing apparatus if the degree of similarity is higher than a specified threshold; otherwise, prompting the user once more to input the gesture information once more on the screen of the data processing apparatus; and
the authentication module is specifically for:
monitoring the gesture information input by the user on the screen lock interface or the desktop interface of the data processing apparatus;
using the gesture information as the authentication sample after the gesture information input by the user is detected, and computing the key path of the authentication sample;
reading the authentication information corresponding to the privacy space from the storage region and comparing the degree of similarity between the key path obtained in the previous step and any key path in the authentication information; and
initiating a certain privacy space in a case where the degree of similarity between the key path obtained in the previous step and any key path in the authentication information corresponding to the privacy space is higher than the corresponding threshold.

14. The device according to claim 10, wherein, the authentication information is a character string plus a specified special character, and the specified interface is a dial interface of the data processing apparatus.

15. The device according to claim 14, wherein, the setting module specifically comprises:
a first setting unit for setting a newly added privacy space and privacy information protected accordingly by the privacy space on the data processing apparatus; and
a second setting unit for prompting the user to input a character string for the newly added privacy space, storing the character string plus a specified special character as the authentication information corresponding to the current privacy space in the storage region of the data processing apparatus after the character string input by the user is received, notifying the user that the authentication information corresponding to the current privacy space is the character string plus the specified special character input by the user; and
the authentication module is specifically for:
monitoring the character string input by the user in the dial interface of the data processing apparatus; reading the authentication information corresponding to the privacy space after the specified special character being input by the user is detected, and comparing the degree of similarity between all of the character string input by the user currently and the authentication information; and
initiating a certain privacy space in a case where all of the character string input by the user currently is fully identical to the authentication information corresponding to the privacy space.

16. The device according to claim 10, wherein, the device further comprises a prompting module for prompting a record of privacy message and privacy incoming call received corresponding to the privacy space on a notice column after initiating the privacy space and adding a prompt icon of the privacy space on the notice column; eliminating the record of the privacy message and privacy incoming call received on the notice column and eliminating the prompt icon of the privacy space after the privacy space is quitted.

17. The device according to claim 10, wherein, the setting module is further for setting a specified shortcut operation for quitting the privacy space;
and the device further comprises a quitting module for monitoring whether the specified shortcut operation occurs after initiating the privacy space and quitting the privacy space when it detects that the specified shortcut operation has occur.

18. The device according to claim 10, wherein, the device further comprises a quitting module for:
monitoring a duration during which there is no operation after initiating privacy space, and quitting the privacy space when the duration during which there is no operation reaches a predetermined duration; or
monitoring whether screen off event occurs after initiating the privacy space, and quitting the privacy space if the screen off event occurs.

19. A computer program in a computer-readable format for initiating privacy mode of data processing apparatus, the computer program causes the computer to execute the following procedures:
setting a privacy space on the data processing apparatus as privacy mode to protect corresponding privacy information, setting authentication information corresponding to the privacy space and setting a specified interface for inputting the authentication information; and
monitoring input information on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.

20. A computer readable medium in which a computer program in a computer-readable format stored, the computer program being for initiating privacy mode of data processing apparatus, the computer program causing a computer to execute the following procedures:
setting a privacy space on the data processing apparatus as privacy mode to protect corresponding privacy information, setting authentication information corresponding to the privacy space and setting a specified interface for inputting the authentication information; and
monitoring input information on the data processing apparatus at the specified interface of the data processing apparatus, comparing degree of similarity between the input information and the authentication information corresponding to the privacy space after the input information is detected, and initiating the privacy space in a case where the degree of similarity between the input information and the authentication information corresponding to the privacy space is higher than a corresponding threshold.
